(19) United States
(12) Patent Application Publication
(10) Pub. No.: US 2009/0270300 A1
(43) Pub. Date: Oct. 29, 2009

(54) Composition for removing protective layer in fabrication of mems and method for removing same

(75) Inventors: Hiroyuki Uehara, Toyama-shi (JP); Kazuhiro Aoba, Toyama-shi (JP); Gu Xu, Rolla, MO (US); Xing-Fu Zhong, Rolla, MO (US)

Correspondence Address: OLIFF & BERRIDGE, PLC, P.O. BOX 320850, ALEXANDRIA, VA, 22320-4850, US

(73) Assignees: NISSAN CHEMICAL INDUSTRIES, LTD., Tokyo (JP); BREWER SCIENCE, INC., Rolla, MO (US)

(21) Appl. No.: 12/289,206

(22) Filed: Oct. 22, 2008

Related U.S. Application Data
(62) Division of application No. 12/081,912, filed on Apr. 23, 2008.

(51) Int. Cl. C11D 7/32

(52) U.S. Cl. 510/175

(57) ABSTRACT

There is provided a composition that can effectively remove a protective coating and a primer coating that have a resistance to etching solutions and are rendered unnecessary after wet-etching treatment in MEMS fabrication processes, and a method for removing the protective layer. The composition contains (A) at least one organic solvent selected from the group consisting of amides, lactones, pyrrolidones and ketones, (B) water, and (C) a fluoride, in an amount of 80.00 to 99.90 mass %, 0.05 to 12.00 mass %, and 0.05 to 8.00 mass %, respectively. The composition may further contain (D) phosphoric acid, phosphonic acid or phosphinic acid in an amount over 0 mass part to 5.5 mass parts, or (E) an organic amine in an amount over 0 mass part to 45 mass parts, based on 100 mass parts of the composition.

This is a Division of application Ser. No. 12/081,912 filed Apr. 23, 2008. The disclosure of the prior application is hereby incorporated by reference herein in its entirety.

### BACKGROUND OF THE INVENTION

1. Field of the Art

The present invention relates to a composition for removing an etching protective coating that has a resistance to an etching solution used in the fabrication process of micro-electro-mechanical system (hereafter referred to as MEMS) and an underlayer coating (a primer coating) that is used for improving adhesion of the protective coating, and a method for removing these coatings by use of the composition.

2. Description of the Related Art

MEMS are tiny electro-mechanical components produced by a microfabrication to which a lithography technique in conventional semiconductor element manufacture is applied. Specifically, they are components that an actuator for outputting a mechanical driving force and a semiconductor circuit for regulating the actuator are formed on a substrate such as silicon wafer or the like and that the actuator and the semiconductor circuit are connected electrically and mechanically. These components are used as several sensor components such as a velocity sensor, a gyro-sensor or the like, a digital micro-mirror for projector, and so on.

These MEMS devices are fabricated by forming a base material called a mask prepared by making a fine pattern on a substrate such as silicon wafer, and etching the parts other than silicon wafer surface covered with the mask with a special gas or liquid to microfabricate. On the other hand, as patterned wires are provided on the opposing surface of the surface to be etched, the opposing surface requires to be protected so as not to receive any damages. In particular, as the etching in the fabrication process of MEMS is carried out with wet etching treatment by dipping in an alkaline or acid liquid in many cases, it is required to apply a protective coating having a resistance to the used etching liquid on the members to be protected or to coat the surface by use of a special jig and protect them.

There is a method in which a special jig is used in the conventional techniques for protecting the members. Specifically, there is a method in which a coating or a plate made of an inorganic material having a resistance to the etching liquid is adhered on the surface to be protected, and immersed in the etching liquid in a state where it is fixed with a jig so as not to be separated. Another is a method in which only the surface to be processed of a thin silicon wafer is treated by bringing it contact with an etching liquid so that the opposing surface does not come into contact with the liquid. However, the former has problems that the procedures for attaching the jig are troublesome and the procedures are apt to injure devices. In addition, the latter has problems that the etching liquid comes into contact with the opposing surface and thereby the yield is lowered.

Further, there is another method for protecting the members in which an amorphous fluorine resin is coated as a protective coating. In this method, as the protective coating is rendered unnecessary after etching treatment, it is required to be completely removed by an etching treatment without damage to the members. But, although the fluorine resin has a resistance to the wet etching liquid, a special agent liquid such as a mixture of sulfuric acid and hydrogen peroxide should be used or a dry ashing treatment should be carried out in order to completely remove the fluorine resin. However, these treatments do much damage to the members. Therefore, a protective coating that has a resistance to a wet etching liquid and does no damage to the members on removal, a composition for removing the protective coating and a method for removing it by use of the composition are required.

As a protective coating for an alkaline etching liquid, recently acrylonitrile-styrene thermoplastic copolymers and the like are developed (see, US-A-2005/0158538 (2005), WO 2005/072489 (2005)). In addition, in order to improve adhesion to the members such as silicon wafer or the like of the protective coating, a primer coating prepared from organosilane dissolved in an organic solvent have been utilized. In this specification, a member made of a protective coating and a primer coating for improving adhesion to the protective coating is called a protective layer.

For removing the protective coatings comprising acrylonitrile-styrene thermoplastic copolymers, it is known that a treatment with general solvents such as amides or ketones upon heating is effective, but the organosilane primer cannot be completely removed. Thus, it is desired to develop a liquid for removing these coatings simultaneously.

As mentioned above, there is a composition suitable for removing the protective coating or the protective layer that can be generally used widely, and therefore it is the current condition that any protective coatings or layers are applied through a trial and error process. In the meantime, there are disclosed patent publications on cleaning agents for apparatus (see, JP-A-7-201794 (1995) and JP-A-2004-207731 (2004)), resists or anti-reflective coatings used for semiconductor base materials, and removal of residues (see, JP-A-7-271056 (1995), JP-A-8-202052 (1996), JP-A-2004-207731 (2004), JP-A-2004-45774 (2004) and JP-A-2005-223030 (2005)), and cleaning liquids limited to aqueous solutions (see, JP-A-2005-223030 (2005)).

### SUMMARY OF THE INVENTION

An object of the present invention is to provide a composition that can effectively remove a protective layer composed of a protective coating and a primer coating that is rendered unnecessary after etching process applied in MEMS fabrication processes, at the same time and with inhibition of damage to MEMS components; and a method for removing the protective layer. In particular, it is an object of the present invention to provide a composition that can remove at one process a protective layer composed of an etching protective coating containing as a main component an acrylonitrile-styrene thermoplastic copolymer having a resistance to the etching solution used in the fabrication process of MEMS devices or the like and a primer coating used for improvement in adhesion of the protective coating; and a method for removing the protective layer.

As the results of eager study, the present inventors found the following composition for removal of a protective layer and removing method using the same, and completed the present invention.

That is, the present invention relates to the following [1] to [24]:
[1] A composition for removing a protective layer composed of a protective coating and a primer coating for wet-etching process for use in the fabrication process of micro-electro-mechanical systems, containing
(A) at least one organic solvent selected from the group consisting of amides, lactones, pyrrolidones and ketones,
(B) water, and
(C) a fluoride,
   wherein the composition contains the component (A) in an amount of 80.00 to 99.90 mass %, the component (B) in an amount of 0.05 to 12.00 mass %, and the component (C) in an amount of 0.05 to 8.00 mass %.
[2] The composition for removing a protective layer as set forth in [1], further comprising as component (D) at least one selected from the group consisting of phosphoric acid, phosphonic acid and phosphinic acid in an amount over 0 mass part to 5.5 mass parts based on 100 mass parts of the composition containing the component (A) in an amount of 80.00 to 99.90 mass %, the component (B) in an amount of 0.05 to 12.00 mass %, and the component (C) in an amount of 0.05 to 8.00 mass %.
[3] The composition for removing a protective layer as set forth in [1] or [2], further comprising as component (E) an organic amine in an amount over 0 mass part to 45 mass parts based on 100 mass parts of the composition containing the component (A) in an amount of 80.00 to 99.90 mass %, the component (B) in an amount of 0.05 to 12.00 mass %, and the component (C) in an amount of 0.05 to 8.00 mass %.
[4] The composition for removing a protective layer as set forth in any one of [1] to [3], wherein the amides of the component (A) are at least one selected from the group consisting of N,N-dimethyl acetamide, N-methylacetamide, acetamide, formamide, N-methylformamide, N,N-dimethylformamide, N,N-diethylformamide, N-methylpropionamide, amide acetate, dicyandiamide, methacrylamide, N,N-dimethylacrylamide, N-methoxymethylacrylamide, N-butoxymethylacrylamide, t-butylacrylamide, N-t-octylacrylamide, N-methylolacrylamide, o-toluene sulfonamide, p-toluene sulfonamide, p-hydroxyphenylacetamide, benzene sulfonamide, amide oleate, amide atearate, ethylene bis-stearoamide, methylene bis-stearoamide, and methylol stearoamide.
[5] The composition for removing a protective layer as set forth in any one of [1] to [3], wherein the lactones of the component (A) are at least one selected from the group consisting of γ-butyrolactone, α-methylene-γ-butyrolactone, γ-methylene-γ-butyrolactone, 2-acetylbutyrolactone, α-acetyl-α-methyl-γ-butyrolactone, 2-hydroxy-γ-butyrolactone, α-bromo-γ-butyrolactone, γ-phenyl-γ-butyrolactone, α,α-diphenyl-γ-butyrolactone, γ-octanoic lactone, ε-caprolactone, β-propiolactone, γ-valerolactone and δ-valerolactone.
[6] The composition for removing a protective layer as set forth in any one of [1] to [3], wherein the pyrrolidones of the component (A) are at least one selected from the group consisting of N-methyl-2-pyrrolidone and 2-pyrrolidone.
[7] The composition for removing a protective layer as set forth in any one of [1] to [3], wherein the ketones of the component (A) are at least one selected from the group consisting of acetone, diethyl ketone, diisopropyl ketone, diisobutyl ketone, dicyclopropyl ketone, cyclohexanone, methyl ethyl ketone, methyl isobutyl ketone, methyl-t-butyl ketone, methyl isopropyl ketone, methyl propyl ketone, methyl cyclopropyl ketone, methyl isopentyl ketone, methyl pentyl ketone, N-butyl ethyl ketone, 1-adamantyl methyl ketone, cyclopropyl phenyl ketone, cyclopropyl 4-fluorophenyl ketone, and methyl 1-methylcyclopropyl ketone.
[8] The composition for removing a protective layer as set forth in any one of [1] to [3], wherein the fluoride of the component (C) is at least one selected from the group consisting of hydrogen fluoride, hydrofluoric acid, acid ammonium fluoride, neutral ammonium fluoride, borofluoric acid, ammonium borofluoride, and trifluoroacetic acid.
[9] The composition for removing a protective layer as set forth in any one of [1] to [3], wherein the fluoride of the component (C) is at least one selected from the group consisting of hydrogen fluoride and hydrofluoric acid.
[10] The composition for removing a protective layer as set forth in [2] or [3], wherein the component (D) is phosphinic acid.
[11] The composition for removing a protective layer as set forth in [3], wherein the organic amine of the component (E) is at least one selected from the group consisting of triethanol amine, diethanol amine, methyl diethanol amine, hydroxyethyl piperazine, hydroxypropyl piperazine, aminoethyl piperazine, aminopropyl piperazine, hydroxyethyl morpholine, hydroxypropyl morpholine, aminoethyl morpholine, aminopropyl morpholine, pentamethyl diethylnene triamine, dimethylamino ethoxy ethanol, aminoethoxy ethanol, trimethylamino ethyl ethanol amine, trimethylamino propyl ethanol amine, N-(2-cyanoethyl) ethylene diamine, and N-(2-cyanopropyl) ethylene diamine.
[12] The composition for removing a protective layer as set forth in [1], wherein the component (A) is at least one selected from the group consisting of dimethyl acetamide, N-methylpyrrolidone and γ-caprolactone, the component (B) is water, and the component (C) is at least one selected from the group consisting of hydrogen fluoride and hydrofluoric acid.
[13] The composition for removing a protective layer as set forth in [2] or [3], wherein the component (A) is at least one selected from the group consisting of dimethyl acetamide, N-methylpyrrolidone and γ-caprolactone, the component (B) is water, and the component (C) is at least one selected from the group consisting of hydrogen fluoride and hydrofluoric acid, and further the component (D) is phosphinic acid.
[14] The composition for removing a protective layer as set forth in [3], wherein the component (A) is at least one selected from the group consisting of dimethyl acetamide, N-methylpyrrolidone and γ-caprolactone, the component (B) is water, and the component (C) is at least one selected from the group consisting of hydrogen fluoride and hydrofluoric acid, and further the component (E) is at least one selected from the group consisting of methyl diethanol amine and triethanol amine.
[15] The composition for removing a protective layer as set forth in [3], wherein the component (A) is at least one selected from the group consisting of dimethyl acetamide, N-methylpyrrolidone and γ-caprolactone, the component (B) is water, and the component (C) is at least one selected from the group consisting of hydrogen fluoride and hydrofluoric acid, the component (D) is phosphinic acid, and further the component (E) is at least one selected from the group consisting of methyl diethanol amine and triethanol amine.
[20] A method for removing a protective layer composed of a protective coating and a primer coating for wet-etching process for use in the fabrication process of micro-electro-mechanical systems, by using a composition for removing the, protective layer containing
(A) at least one organic solvent selected from the group consisting of amides, lactones, pyrrolidones and ketones,
(B) water, and
(C) a fluoride,
   wherein the composition contains the component (A) in an amount of 80.00 to 99.90 mass %, the component (B) in an amount of 0.05 to 12.00 mass %, and the component (C) in an amount of 0.05 to 8.00 mass %.
[21] The method for removing a protective layer as set forth in [20], by using a composition for removing the protective layer further containing as component (D) at least one selected from the group consisting of phosphoric acid, phosphonic acid and phosphinic acid in an amount over 0 mass part to 5.5 mass parts based on 100 mass parts of the composition containing the component (A) in an amount of 80.00 to 99.90 mass %, the component (B) in an amount of 0.05 to 12.00 mass %, and the component (C) in an amount of 0.05 to 8.00 mass %.
[22] The method for removing a protective layer as set forth in [20] or [21], by using a composition for removing the protective layer further containing as component (E) an organic amine in an amount over 0 mass part to 45 mass parts based on 100 mass parts of the composition containing the component (A) in an amount of 80.00 to 99.90 mass %, the component (B) in an amount of 0.05 to 12.00 mass %, and the component (C) in an amount of 0.05 to 8.00 mass %.
[23] The method for removing a protective layer as set forth in [20], by using a composition for removing the protective layer further containing as component (D) at least one selected from the group consisting of phosphoric acid, phosphonic acid and phosphinic acid in an amount over 0 mass part to 5.5 mass parts and as component (E) an organic amine in an amount over 0 mass part to 45 mass parts, based on 100 mass parts of the composition containing the component (A) in an amount of 80.00 to 99.90 mass %, the component (B) in an amount of 0.05 to 12.00 mass %, and the component (C) in an amount of 0.05 to 8.00 mass %.
[24] The method for removing a protective layer as set forth in any one of [20] to [23], wherein the protective layer comprises a protective coating and a primer coating for wet-etching process for use in the fabrication process of micro-electro-mechanical systems, wherein the primer coating is a coating prepared from an organosilane and/or an aromatic silane dissolved in an organic solvent, and the protective coating is a coating made of a thermoplastic copolymer prepared from (a) styrene, (b) acrylonitrile, and (c) optionally at least one monomer selected from the group consisting of methacrylate, acrylate, vinyl benzyl chloride, and diester of maleic acid or fumaric acid.

The method for removing a protective layer as set forth in any one of [20] to [23], wherein the protective layer comprises a protective coating and a primer coating for wet-etching process for use in the fabrication process of micro-electro-mechanical systems, wherein the primer coating is a coating prepared from an organosilane and/or an aromatic silane dissolved in an organic solvent, and the protective coating is a coating made of a thermoplastic copolymer prepared from (a) styrene, (b) acrylonitrile, and (c) optionally at least one monomer selected from the group consisting of methacrylate, acrylate, vinyl benzyl chloride, and diester of maleic acid or fumaric acid.

The method for removing a protective layer as set forth in any one of [20] to [23], wherein the protective layer comprises a protective coating and a primer coating for wet-etching process for use in the fabrication process of micro-electro-mechanical systems, wherein the primer coating is a coating prepared from an organosilane and/or an aromatic silane dissolved in an organic solvent, and the protective coating is a coating made of a thermoplastic copolymer prepared from (a) styrene and (b) acrylonitrile.

The method for removing a protective layer as set forth in any one of [20] to [23], wherein the protective layer comprises a protective coating and a primer coating for wet-etching process for use in the fabrication process of micro-electro-mechanical systems, wherein the primer coating is a coating prepared from a solution obtained by dissolving 3-[N-phenylamino]propyltrimethoxysilane in an organic solvent, and the protective coating is a coating made of a thermoplastic copolymer prepared from (a) styrene and (b) acrylonitrile.

The composition for removing a protective layer according to the present invention is effective for removing a protective layer or the like that has been rendered unnecessary after wet-etching process applied in MEMS fabrication processes for example MEMS devices fabrication processes. In particular, the composition effectively removes the protective layer in which the primer coating is a coating prepared from an organosilane and/or an aromatic silane dissolved in an organic solvent, and the protective coating is a coating made of a thermoplastic copolymer prepared from (a) styrene and (b) acrylonitrile, or a thermoplastic copolymer prepared from (a) styrene, (b) acrylonitrile, and (c) optionally at least one monomer selected from the group consisting of methacrylate, acrylate, vinyl benzyl chloride, and diester of maleic acid or fumaric acid, and the composition is effective for preventing any damage to a metal coating such as SiO₂ coating, Al or the like being a material.

### DESCRIPTION OF THE PREFERRED EMBODIMENTS

The present invention relates to a composition suitable for removing a protective coating and a primer coating that have been rendered unnecessary after wet-etching process in MEMS fabrication processes. The composition contains as essential components, (A) at least one organic solvent selected from the group consisting of amides, lactones, pyrrolidones and ketones, (B) water, and (C) a fluoride.

It is preferable to add in the composition as component (D) at least one selected from the group consisting of phosphoric acid, phosphonic acid and phosphinic acid in order to improve corrosion prevention of MEMS components. Further, is preferable the composition in which an organic amine is added as component (E) for controlling pH range of the composition for corrosion prevention of a tank for treatment liquid, a piping or the like, and for putting it closer to neutrality.

The amides of the organic solvent of the component (A) in the present invention include N,N-dimethyl acetamide, N-methylacetamide, acetamide, formamide, N-methylformamide, N,N-dimethylformamide, N,N-diethylformamide, N-methylpropionamide, amide acetate, dicyandiamide, methacrylamide, N,N-dimethylacrylamide, N-methoxymethylacrylamide, N-butoxymethylacrylamide,.t-butylacrylamide, N-t-octylacrylamide, N-methylolacrylamide, o-toluene sulfonamide, p-toluene sulfonamide, p-hydroxyphenylacetamide, benzene sulfonamide, amide oleate, amide atearate, ethylene bis-stearoamide, methylene bis-stearoamide, and methylol stearoamide, etc.

Among these compounds, N,N-dimethyl acetamide is particularly desirable from the viewpoint of flash point, viscosity, and rinsing properties with pure water after treatment.

The lactones of the organic solvent of the component (A) in the present invention include γ-butyrolactone, α-methylene-γ-butyrolactone, γ-methylene-γ-butyrolactone, 2-acetylbutyrolactone, α-acetyl-α-methyl-γ-butyrolactone, 2-hydroxy-γ-butyrolactone, α-bromo-γ-butyrolactone, γ-phenyl-γ-butyrolactone, α,α-diphenyl-γ-butyrolactone, γ-octanoic lactone, ε-caprolactone, β-propiolactone, γ-valerolactone and δ-valerolactone, etc,

Among these compounds, γ-butyrolactone is particularly desirable from the viewpoint of flash point, viscosity, and universal applicability.

The pyrrolidones of the organic solvent of the component (A) in the present invention include N-methyl-2-pyrrolidone and 2-pyrrolidone.

The ketones of the organic solvent of the component (A) in the present invention include acetone, diethyl ketone, diisopropyl ketone, diisobutyl ketone, dicyclopropyl ketone, cyclohexanone, methyl ethyl ketone, methyl isobutyl ketone, methyl-t-butyl ketone, methyl isopropyl ketone, methyl propyl ketone, methyl cyclopropyl ketone, methyl isopentyl ketone, methyl pentyl ketone, N-butyl ethyl ketone, 1-adamantyl methyl ketone, cyclopropyl phenyl ketone, cyclopropyl 4-fluorophenyl ketone, and methyl 1-methylcyclopropyl ketone, etc. Among these compounds, acetone, methyl ethyl ketone and cyclohexanone are preferably desirable from the viewpoint of universal applicability, although it becomes difficult to treat with heating due to a low flash point.

The fluoride of the component (C) in the present invention includes hydrogen fluoride, hydrofluoric acid, acid ammonium fluoride, neutral ammonium fluoride, borofluoric acid, ammonium borofluoride, and trifluoroacetic acid, etc.

Among these compounds, hydrogen fluoride and hydrofluoric acid are particularly desirable from the viewpoint that residue of the primer coating can be effectively removed. In the meantime, as a commercially available agent, hydrofluoric acid in a form of aqueous solution containing hydrogen fluoride in an amount of 50 to 60 mass % is generally available. Thus, the present invention is evaluated by use of hydrofluoric acid containing hydrogen fluoride in 50 mass %. Therefore, the evaluation is carried out by using a solution containing hydrogen fluoride and water in a proportion of 1:1.

The composition for removing a protective layer according to the present invention contains the organic solvent of the component (A) in an amount of 80.00 to 99.90 mass %, water of the component (B) in an amount of 0.05 to 12.00 mass %, and the fluoride of the component (C) in an amount of 0.05 to 8.00 mass %.

More preferably, the composition contains the component (A) in an amount of 91.00 to 99.90 mass %, the component (B) in an amount of 0.05 to 6.00 mass %, and the component (C) in an amount of 0.05 to 3.00 mass %. Particularly preferably, the composition contains the component (A) in an amount of 98.00 to 99.90 mass %, the component (B) in an amount of 0.05 to 1.00 mass %, and the component (C) in an amount of 0.05 to 1.00 mass %.

When the amount of the component (A) is less than 80.00 mass %, the composition has low properties for removing a protective coating made of a thermoplastic copolymer containing (a) styrene and (b) acrylonitrile that are monomer units. On the other hand, when the amount is more than 99.90 mass %, the composition has low properties for removing a primer coating applied for improving adhesion, for example an organosilane primer.

When the amount of water of the component (B) is more than 12.00 mass %, the properties for removing a protective coating are deteriorated. In the present invention, it is enough to contain water in as small an amount as possible, and it is presumed that the amount of water may be 0 mass %. In the meantime, as hydrofluoric acid is used as an agent for evaluation in this specification, water is contained therein in 0.05 mass % being the minimum amount.

When the amount of the fluoride of the component (C) is less than 0.05 mass %, the properties for removing a primer coating are deteriorated. On the other hand, when the amount is more than 8.00 mass %, the corrosive properties of MEMS components become high, damages to the components become large, and thus it is not preferable.

It is preferable to inhibit the corrosive properties to the MEMS components that the composition for removing a protective layer according to the present invention contains further as component (D) at least one selected from the group consisting of phosphoric acid, phosphonic acid and phosphinic acid in an amount over 0 mass part to 5.5 mass parts, preferably 0.1 to 5.5 mass parts based on 100 mass parts of the composition containing the component (A), the component (B) and the component (C) in each amount in the prescribed range.

It is also preferable that the composition for removing a protective layer according to the present invention contains further component (E) an organic amine in an amount over 0 mass part to 45 mass parts based on 100 mass parts of the composition containing the component (A), the component (B) and the component (C) in each amount in the prescribed range, or also in case where the component (D) is contained, component (E) an organic amine in an amount over 0 mass part to 45 mass parts based on 100 mass parts of the composition containing the component (A), the component (B) and the component (C) in each amount in the prescribed range, because the component (E) can adjust pH of the composition for removing a protective layer, and make it a neutral solution from a strongly acidic solution, and thus make possible to apply the composition for removing a protective layer in a wide range. For example, the use of the component (E) makes possible to select materials for a tank for treatment liquid, a piping or the like from a wide scope. In the meantime, the amount more than 45 mass parts is not preferable as the properties for removing the protective coating are deteriorated.

The organic amine of the component (E) used in the present invention includes triethanol amine, diethanol amine, methyl diethanol amine, hydroxyethyl piperazine, hydroxypropyl piperazine, aminoethyl piperazine, aminopropyl piperazine, hydroxyethyl morpholine, hydroxypropyl morpholine, aminoethyl morpholine, aminopropyl morpholine, pentamethyl diethylnene triamine, dimethylamino ethoxy ethanol, aminoethoxy ethanol, trimethylamino ethyl ethanol amine, trimethylamino propyl ethanol amine, N-(2-cyanoethyl) ethylene diamine, N-(2-cyanopropyl) ethylene diamine, and the like.

The organic amine as component (E) can be contained in an amount over 0 mass part to 45 mass parts, preferably 1 to 45 mass parts based on 100 mass parts of the composition containing the component (A) in an amount of 80.00 to 99.90 mass %, the component (B) in an amount of 0.05 to 12.00 mass %, and the component (C) in an amount of 0.05 to 8.00 mass %.

The composition for removing a protective layer according to the present invention can contain other organic solvents, organic acids, inorganic acids, surfactants, chelating agents and the like so long as they do not injure the effects of the composition.

As other organic solvents, 1,4-butane diol, 1,3-butane diol, ethylene glycol, propylene glycol, propylene glycol monomethyl ether, propylene glycol monomethyl ether acetate, dioxane, chlorobenzene, cyclohexanone, tetrahydrofuran, dimethyl sulfoxide, dimethyl sulfone, tetramethylene sulfoxide, tetramethylene sulfone, benzene, toluene, xylene, chloroform, carbon tetrachloride and the like can be added so long as it does not injure the effects of the composition for removing a protective layer.

In addition, the inorganic acids such as boric acid, hydrochloric acid sulfuric acid and the like, or the organic acids such as gluconic acid, ascorbic acid, iminodiacetic acid, citric acid and the like can be added for the adjustment of pH.

Further, the chelating agents such as mannitol, sorbitol, ethylene diamine tetra-acetic acid, diethylene triamine penta-acetic acid and the like can be added for the prevention of corrosion.

The surfactants such as C, ,oalkyl glucosides (for example decylglucoside), long chain fatty acids, glycerin esters, sorbitan esters, polyalkylene glycol esters, sulfonated fatty acids and the dervatives thereof, alcohols of long chain type, alkyl polysiloxanes and the like can be added for the prevention of corrosion.

The composition for removing a protective layer according to the present invention is applied for the removal of the protective layer composed of a primer coating obtained from an organosilane and/or an aromatic silane and a protective coating applied on the primer coating obtained from a thermoplastic resin. In particular, the composition is preferably applied for the protective layer wherein the primer coating is a coating obtained from an organosilane and/or an aromatic silane dissolved in an organic solvent, or a coating obtained from a solution obtained by dissolving 3-[N-phenylamino]propyltrimethoxysilane in an organic solvent. In addition, the composition is preferably applied for the protective layer wherein the protective coating is a coating made of a thermoplastic copolymer prepared from (a) styrene and (b) acrylonitrile, or a thermoplastic copolymer prepared from (a) styrene, (b) acrylonitrile and (c) optionally at least one monomer selected from the group consisting of methacrylate, acrylate, vinyl benzyl chloride, and diester of maleic acid or fumaric acid.

Concretely, the composition of the present invention can be applied for an etching protective coating containing acrylonitrile-styrene thermoplastic copolymer as a main component, and a primer coating used for an improvement of adhesion of the protective coating.

The composition for removing a protective layer can be used as such in cleaning agents for apparatus as mentioned above or cleaning apparatus used for removal of resists and anti-reflective coatings used for semiconductor base materials, and residues thereof, and the like, and does not require specifically new cleaning tanks or pipings or the like.

The temperature at which the composition for removing a protective layer is used is not limited so long as aimed layers can be completely removed, and sufficient effects are exerted for example at a temperature of 20 to 60° C.

The time for which the composition for removing a protective layer is used is not limited so long as aimed layers can be completely removed, and sufficient effects are exerted for example at a time of 20 to 60 minutes.

The mode in which the composition for removing a protective layer is used is not limited so long as the composition contacts the objects to be removed, and the use in the apparatus of immersion type is preferable.

### EXAMPLES

Hereinafter, the present invention will be described based on examples to which the present invention is not limited.

### (Evaluation of Removability of Primer Coating)

(1) A primer coating (hereinafter referred to as “Primer A”) was prepared by adding 1.0 g of 3-aminopropyltriethoxysilane (obtained from Gelest, Inc, Morrisville, Pa.) into 95 g of PGME and 5 g of water. The primer was aged for at least 24 hours so that the silane was partially hydrolyzed and condensed. The primer was then filtered using a 0.2/0.45-μm polypropylene filter. Primer A was coated on a silicon wafer by means of a spinner at 1500 rpm for 60 seconds, and thus baked at 130° C. for 60 seconds to form a coating having a film thickness of 12 to 15 nm. The resulting coating was used as a sample for evaluation.

The sample for evaluation was immersed in compositions for removal shown in Examples and Comparative Examples at 50° C. for 10 minutes. Thereafter, the sample was washed with water and dried in air, and the removability of the coating was evaluated.

In the meantime, when the composition for removal in which acetone was used as an organic solvent of the component (A) was used, the immersion was carried out at 23° C. for 10 minutes, and then the sample was washed with water and dried in air, thereafter the removability of the coating was evaluated. The removability was comprehensively determined by film thickness measurement with an ellipsometer (DUV-VASE manufactured by J. A. Woollam Co., Inc.) and a contact angle to water. The contact angle to water was measured with a contact angle meter A-W150 manufactured by Kyowa Interface Science Co., Ltd. by applying 50 μl of water drop. The evaluation was carried out based on the following criteria:

∘: No remaining coating by film thickness measurement (less than detection limit) and contact angle equivalent to that of silicon wafer;

Δ: Coating cannot be removed by the standard immersion for 20 minutes but can be removed by immersion by 30 minutes, and the above-mentioned evaluation belongs to “∘”;

x: Remaining coating is confirmed by film thickness measurement, and contact angle different from that of silicon wafer, or coating residue is confirmed visually.

### (Evaluation of Removability of Protective Coating)

(2) A protective coating composition (hereinafter referred to as “Protective Coating A”) was formulated by dissolving 12 g of poly(styrene-co-acrylonitrile) (SAN30: M_{w}=185,000, 30 wt % acrylonitrile, available from Aldrich) in 44 g of methyl isoamyl ketone (MIAK) and 44 g of di(ethylene glycol) dimethyl ether. The coating composition was filtered twice using a 0.2/0.45-μm polypropylene filter. ProtectiveCoating A was coated on a silicon wafer by means of a spinner at 100 rpm for 10 seconds and then at 1000 rpm for 10 seconds, and thus baked at. 100° C. for 60 seconds, 130° C. for 60 seconds and 160° C. for 60 seconds in that order at gradually a higher temperature to form a coating having a film thickness of 10 μm. The resulting coating was used as a sample for evaluation.

The sample for evaluation was immersed in compositions for removal shown in Examples and Comparative Examples at 55° C. for 20 minutes. Thereafter, the sample was washed with water and dried in air, and the removability of the coating was evaluated.

In the meantime, when the composition for removal in which acetone was used as an organic solvent of the component (A) was used, the immersion was carried out at 23° C. for 10 minutes, and then the sample was washed with water and dried in air, thereafter the removability of the coating was evaluated. The removability was determined by film thickness measurement with Nanospec (AFT 6100 manufactured by Nanometrics Japan, Ltd.) and a visual check of appearance.

The evaluation was carried out based on the following criteria:

∘: No remaining coating by film thickness measurement (less than detection limit) and contact angle equivalent to that of silicon wafer, or no whitening after immersion in water is confirmed;

x: Remaining coating is confirmed by film thickness measurement, and contact angle different from that of silicon wafer, or whitening after immersion in water is confirmed.

### (Evaluation of Etching Rate of SiO₂)

A commercially available wafer substrate having SiO₂ coating (thickness 100 nm) was cut in a size of about 2 to 3 cm square to prepare a sample for evaluation.

The sample for evaluation was immersed in compositions for removal shown in Examples and Comparative Examples at 55° C for 5 to 20 minutes. Thereafter, the sample was washed with water and dried in air, and the etching rate of SiO₂ was evaluated.

In the meantime, when the composition for removal in which acetone was used as an organic solvent of the component (A) was used, the immersion was carried out at 23° C. for 10 minutes, and then the sample was washed with water and dried in air, thereafter the etching rate of SiO₂ was evaluated. The film thickness was measured with measurement with Nanospec (AFT 6100 manufactured by Nanometrics Japan, Ltd.), and the etching rate of SiO₂ was determined from difference in film thickness between before and after of treatment, and treatment time.

### (Evaluation of Etching Rate of Al)

A commercially available wafer substrate having Al coating (thickness 500 nm) was cut in a size of about 2 to 3 cm square to prepare a sample for evaluation.

The sample for evaluation was immersed in compositions for removal shown in Examples and Comparative Examples at 55° C. for 2 to 10 minutes. Thereafter, the sample was washed with water and dried in air, and the etching rate of Al was evaluated.

In the meantime, when the composition for removal in which acetone was used as an organic solvent of the component (A) was used, the immersion was carried out at 23° C. for 10 minutes, and then the sample was washed with water and dried in air, thereafter the etching rate of Al was evaluated.

Resistances before and after treatment were measured with a sheet resistance meter (VR-120S manufactured by Hitachi Kokusai Denki Engineering Co., Ltd.), the resulting measurement values were converted to film thickness, and the etching rate of Al was determined from difference in film thickness between before and after of treatment, and treatment time.

The measurement of pH was carried out in a composition for removal diluted ten times under a condition of a temperature of 23° C. with a pH meter manufactured by Eutech Instruments Pte Ltd. (Waterproof pH Testr10, otherwise known as LACOM pH tester).

Each component of compositions for removal of Examples 1 to 77 and Comparative Examples 1 to 15 and evaluation results are shown in Tables 1 to 9. In the meantime, the abbreviations in the tables have the following meanings:
DMAC: Dimethyl acetamide
NMP: N-Methyl pyrrolidone
γ-BL: γ-Butyrolactone
HF: Hydrogen fluoride
Water: DIW
H₃PO₄: Phosphoric acid
H₃PO₃: Phosphonic acid
H₃PO₂: Phosphinic acid
MDEA: Methyl diethanol amine
TEA: Triethanol amine
P. P-R: Primer A removability
P. B-R: Protective Coating A removability
SiO₂-ER: SiO₂ etching rate (nm/min.)
AL-ER: Al etching rate (nm/min.)
pH: pH in solution diluted at 10 times with pure water
In addition, the amount of each component in the composition is shown in mass % based on the total mass of the composition.

Tables 1 to 9

The composition for removing a protective layer according to the present invention in which each component is contained in the prescribed range is effective for removing a protective layer made of a protective coating and a primer coating, and for preventing any damage to a metal coating such as SiO₂ coating, Al or the like being a material. In particular, the pH range of the composition is not limited so long as it can completely remove aimed materials, for example the composition shows a good anticorrosion even at pH of c.a. 1.5 to c.a. 3 in case where it is diluted at 10 times with pure water. It is assumed that corrosion of Al or SiO₂ that is frequently used as a material is inhibited also in the above-mentioned pH range. It is generally anticipated that Al may increase in corrosion at a strongly acidic or strongly alkaline range as Al is an amphoteric metal. However, Al in the composition of the present invention is specifically stable at a strongly acidic range. Further, the composition neutralized by adjustment of pH from a strongly acidic solution also exerts anticorrosion.

### INDUSTRIAL APPLICABILITY

The present invention provides a composition that can effectively remove a protective layer composed of a protective coating and a primer coating for etching used in MEMS fabrication processes, at the same time and with inhibition of damage to MEMS components, and a method for removing the protective layer. Therefore, the present invention is useful in the fabrication of MEMS devices and the like.

TABLE 1

| | Example | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Composition | | | | | | | | | | | | | |
| DMAC | 99.90 | 99.80 | 98.90 | 98.75 | 98.50 | 98.00 | 96.00 | 94.00 | 92.00 | 89.00 | 88.00 | 95.00 | 90.00 |
| NMP | | | | | | | | | | | | | |
| γ-BL | | | | | | | | | | | | | |
| ACETONE | | | | | | | | | | | | | |
| HF | 0.05 | 0.10 | 0.10 | 0.25 | 0.50 | 1.00 | 1.00 | 1.00 | 1.00 | 1.00 | 1.00 | 2.00 | 5.00 |
| DIW | 0.05 | 0.10 | 1.00 | 1.00 | 1.00 | 1.00 | 3.00 | 5.00 | 7.00 | 10.00 | 11.00 | 3.00 | 5.00 |
| H3PO4 | | | | | | | | | | | | | |
| H3PO3 | | | | | | | | | | | | | |
| H3PO2 | | | | | | | | | | | | | |
| MDEA | | | | | | | | | | | | | |
| TEA | | | | | | | | | | | | | |
| Evaluation Results | | | | | | | | | | | | | |
| P.P-R | ◯ | ◯ | ◯ | ◯ | ◯ | ◯ | ◯ | ◯ | ◯ | ◯ | ◯ | ◯ | ◯ |
| P.B-R | ◯ | ◯ | ◯ | ◯ | ◯ | ◯ | ◯ | ◯ | Δ | Δ | Δ | ◯ | ◯ |
| SiO2-ER | 0.01 | 0.01 | 0.04 | 0.00 | 0.00 | 0.05 | 0.11 | 0.05 | 0.06 | 0.08 | 0.07 | 0.10 | 0.32 |
| AL-ER | 0.28 | 0.42 | 1.70 | 2.10 | 2.40 | 4.90 | 8.00 | 11.30 | 18.40 | 27.50 | 30.40 | 9.00 | 25.60 |
| pH | 3.20 | 3.00 | 2.90 | 2.40 | 2.40 | 3.10 | 2.70 | 3.00 | 3.00 | 2.70 | 2.50 | 3.30 | 3.00 |

TABLE 2

| | Example | | | | | | | | | | | |
|---|---|---|---|---|---|---|---|---|---|---|---|---|
| | 14 | 15 | 16 | 17 | 18 | 19 | 20 | 21 | 22 | 23 | 24 | 25 |
| Composition | | | | | | | | | | | | |
| DMAC | | | | | | | | | | | | |
| NMP | 99.90 | 99.80 | 98.90 | 98.75 | 98.50 | 98.00 | 96.00 | 94.00 | 92.00 | 89.00 | 95.00 | 90.00 |
| γ-BL | | | | | | | | | | | | |
| ACETONE | | | | | | | | | | | | |
| HF | 0.05 | 0.10 | 0.10 | 0.25 | 0.50 | 1.00 | 1.00 | 1.00 | 1.00 | 1.00 | 2.00 | 5.00 |
| DIW | 0.05 | 0.10 | 1.00 | 1.00 | 1.00 | 1.00 | 3.00 | 5.00 | 7.00 | 10.00 | 3.00 | 5.00 |
| H3PO4 | | | | | | | | | | | | |
| H3PO3 | | | | | | | | | | | | |
| H3PO2 | | | | | | | | | | | | |
| MDEA | | | | | | | | | | | | |
| TEA | | | | | | | | | | | | |
| Evaluation Results | | | | | | | | | | | | |
| P.P-R | ◯ | ◯ | ◯ | ◯ | ◯ | ◯ | ◯ | ◯ | ◯ | ◯ | ◯ | ◯ |
| P.B-R | ◯ | ◯ | ◯ | ◯ | ◯ | ◯ | ◯ | ◯ | Δ | Δ | ◯ | ◯ |
| SiO2-ER | 0.01 | 0.04 | 0.03 | 0.04 | 0.03 | 0.03 | 0.02 | 0.02 | 0.04 | 0.05 | 0.30 | 0.13 |
| AL-ER | 0.48 | 0.39 | 0.80 | 0.90 | 1.10 | 2.60 | 3.40 | 5.80 | 12.60 | 18.30 | 18.3 | 17.10 |
| pH | 3.10 | 2.90 | 2.90 | 2.60 | 2.50 | 2.90 | 2.90 | 2.60 | 3.00 | 2.30 | 3.10 | 3.00 |

TABLE 3

| | Example | | | | | | | | | | | | |
|---|---|---|---|---|---|---|---|---|---|---|---|---|---|
| | 26 | 27 | 28 | 29 | 30 | 31 | 32 | 33 | 34 | 35 | 36 | 37 | 38 |
| Composition | | | | | | | | | | | | | |
| DMAC | | | | | | | | | | | | | |
| NMP | | | | | | | | | | | | | |
| γ-BL | 99.90 | 99.80 | 98.90 | 98.75 | 98.50 | 98.00 | 96.00 | 94.00 | 92.00 | 89.00 | 95.00 | 90.00 | |
| ACETONE | | | | | | | | | | | | | 98.00 |
| HF | 0.05 | 0.10 | 0.10 | 0.25 | 0.50 | 1.00 | 1.00 | 1.00 | 1.00 | 1.00 | 2.00 | 5.00 | 1.00 |
| DIW | 0.05 | 0.10 | 1.00 | 1.00 | 1.00 | 1.00 | 3.00 | 5.00 | 7.00 | 10.00 | 3.00 | 5.00 | 1.00 |
| H3PO4 | | | | | | | | | | | | | |
| H3PO3 | | | | | | | | | | | | | |
| H3PO2 | | | | | | | | | | | | | |
| MDEA | | | | | | | | | | | | | |
| TEA | | | | | | | | | | | | | |
| Evaluation Results | | | | | | | | | | | | | |
| P.P-R | ◯ | ◯ | ◯ | ◯ | ◯ | ◯ | ◯ | ◯ | ◯ | ◯ | ◯ | ◯ | ◯ |
| P.B-R | ◯ | ◯ | ◯ | ◯ | ◯ | ◯ | ◯ | ◯ | Δ | Δ | ◯ | ◯ | ◯ |
| SiO2-ER | 0.01 | 0.01 | 0.01 | 0.03 | 0.05 | 0.11 | 0.27 | 0.31 | 0.86 | 0.79 | 0.71 | 3.20 | 0 |
| AL-ER | 0.33 | 0.27 | 0.60 | 0.60 | 0.60 | 0.60 | 1.40 | 1.00 | 4.70 | 3.80 | 2.00 | 2.20 | 0.3 |
| pH | 3.00 | 2.80 | 2.80 | 2.70 | 2.50 | 3.00 | 3.00 | 2.20 | 2.70 | 2.40 | 3.00 | 3.00 | 2.8 |

TABLE 4

| | Example | | | | | | | | |
|---|---|---|---|---|---|---|---|---|---|
| | 39 | 40 | 41 | 42 | 43 | 44 | 45 | 46 | 47 |
| Composition | | | | | | | | | |
| DMAC | 70.00 | 50.00 | 28.00 | 70.00 | 50.00 | 28.00 | | | |
| NMP | 28.00 | 48.00 | 70.00 | | | | 70.00 | 50.00 | 28.00 |
| γ-BL | | | | 28.00 | 48.00 | 70.00 | 28.00 | 48.00 | 70.00 |
| ACETONE | | | | | | | | | |
| HF | 1.00 | 1.00 | 1.00 | 1.00 | 1.00 | 1.00 | 1.00 | 1.00 | 1.00 |
| DIW | 1.00 | 1.00 | 1.00 | 1.00 | 1.00 | 1.00 | 1.00 | 1.00 | 1.00 |
| H3PO4 | | | | | | | | | |
| H3PO3 | | | | | | | | | |
| H3PO2 | | | | | | | | | |
| MDEA | | | | | | | | | |
| TEA | | | | | | | | | |
| Evaluation Results | | | | | | | | | |
| P.P-R | ◯ | ◯ | ◯ | ◯ | ◯ | ◯ | ◯ | ◯ | ◯ |
| P.B-R | ◯ | ◯ | ◯ | ◯ | ◯ | ◯ | ◯ | ◯ | ◯ |
| SiO2-ER | 0.06 | 0.06 | 0.02 | 0.04 | 0.08 | 0.21 | 0.02 | 0.03 | 0.13 |
| AL-ER | 3.50 | 2.70 | 2.30 | 4.00 | 5.60 | 8.00 | 2.50 | 2.60 | 5.20 |
| pH | 2.10 | 2.20 | 2.30 | 2.70 | 2.70 | 2.60 | 2.40 | 2.50 | 2.60 |

TABLE 5

| | Example | | | | | | | | | | |
|---|---|---|---|---|---|---|---|---|---|---|---|
| | 48 | 49 | 50 | 51 | 52 | 53 | 54 | 55 | 56 | 57 | 58 |
| Composition | | | | | | | | | | | |
| DMAC | 96.50 | 95.00 | 93.50 | 93.00 | 92.00 | 89.00 | 89.00 | 89.00 | 83.00 | 83.00 | 83.00 |
| NMP | | | | | | | | | | | |
| γ-BL | | | | | | | | | | | |
| ACETONE | | | | | | | | | | | |
| HF | 1.00 | 1.00 | 1.00 | 1.00 | 1.00 | 1.00 | 1.00 | 1.00 | 1.00 | 1.00 | 1.00 |
| DIW | 2.00 | 3.00 | 5.00 | 5.00 | 5.00 | 7.00 | 7.00 | 7.00 | 11.00 | 11.00 | 11.00 |
| H3PO4 | | | | | | | | 3.00 | | | 5.00 |
| H3PO3 | | | | | | | 3.00 | | | 5.00 | |
| H3PO2 | 0.50 | 1.00 | 0.50 | 1.00 | 2.00 | 3.00 | | | 5.00 | | |
| MDEA | | | | | | | | | | | |
| TEA | | | | | | | | | | | |
| Evaluation Results | | | | | | | | | | | |
| P.P-R | ◯ | ◯ | ◯ | ◯ | ◯ | ◯ | ◯ | ◯ | ◯ | ◯ | ◯ |
| P.B-R | ◯ | ◯ | ◯ | ◯ | ◯ | Δ | Δ | Δ | Δ | Δ | Δ |
| SiO2-ER | 0.04 | 0.05 | 0.03 | 0.05 | 0.04 | 0.05 | 0.05 | 0.06 | 0.08 | 0.08 | 0.10 |
| AL-ER | 3.70 | 3.90 | 8.70 | 7.80 | 5.70 | 6.90 | 6.70 | 9.60 | 7.40 | 14.90 | 20.90 |
| pH | 2.60 | 2.20 | 2.70 | 2.30 | 2.40 | 1.80 | 1.90 | 2.20 | 1.80 | 1.80 | 2.00 |

TABLE 6

| | Example | | | | | | | |
|---|---|---|---|---|---|---|---|---|
| | 59 | 60 | 61 | 62 | 63 | 64 | 65 | 66 |
| Composition | | | | | | | | |
| DMAC | | | | | | | | |
| NMP | 95.00 | 91.00 | 89.00 | 83.00 | | | | |
| γ-BL | | | | | 95.00 | 91.00 | 89.00 | 83.00 |
| ACETONE | | | | | | | | |
| HF | 1.00 | 1.00 | 1.00 | 1.00 | 1.00 | 1.00 | 1.00 | 1.00 |
| DIW | 3.00 | 7.00 | 7.00 | 11.00 | 3.00 | 7.00 | 7.00 | 11.00 |
| H3PO4 | | | | | | | | |
| H3PO3 | | | | | | | | |
| H3PO2 | 1.00 | 1.00 | 3.00 | 5.00 | 1.00 | 1.00 | 3.00 | 5.00 |
| MDEA | | | | | | | | |
| TEA | | | | | | | | |
| Evaluation | | | | | | | | |
| Results | | | | | | | | |
| P.P-R | ◯ | ◯ | ◯ | ◯ | ◯ | ◯ | ◯ | ◯ |
| P.B-R | ◯ | Δ | Δ | Δ | ◯ | Δ | Δ | Δ |
| SiO2-ER | 0.02 | 0.03 | 0.03 | 0.05 | 0.70 | 1.17 | 1.54 | 2.41 |
| AL-ER | 3.50 | 9.80 | 4.00 | 4.5 | 0.70 | 2.80 | 0.50 | 0.7 |
| pH | 2.20 | 2.60 | 1.90 | 1.7 | 2.00 | 2.50 | 2.10 | 2.1 |

TABLE 7

| | Example | | | | | | | | | | |
|---|---|---|---|---|---|---|---|---|---|---|---|
| | 67 | 68 | 69 | 70 | 71 | 72 | 73 | 74 | 75 | 76 | 77 |
| Composition | | | | | | | | | | | |
| DMAC | 90.00 | 90.00 | 80.00 | 70.00 | 60.00 | 85.00 | | | 70.00 | | |
| NMP | | | | | | | 85.00 | | | 70.00 | |
| γ-BL | | | | | | | | 85.00 | | | 70.00 |
| ACETONE | | | | | | | | | | | |
| HF | 1.00 | 1.00 | 5.00 | 5.00 | 5.00 | 1.00 | 1.00 | 1.00 | 1.00 | 1.00 | 1.00 |
| DIW | 3.00 | 3.00 | 5.00 | 5.00 | 5.00 | 1.00 | 1.00 | 1.00 | 1.00 | 1.00 | 1.00 |
| H3PO4 | | | | | | | | | | | |
| H3PO3 | | | | | | | | | | | |
| H3PO2 | | | | | | | | | | | |
| MDEA | 5.00 | | 10.00 | 20.00 | 30.00 | 13.00 | 13.00 | 13.00 | 28.00 | 28.00 | 28.00 |
| TEA | | 5.00 | | | | | | | | | |
| Evaluation Results | | | | | | | | | | | |
| P.P-R | ◯ | ◯ | ◯ | ◯ | ◯ | ◯ | ◯ | ◯ | ◯ | ◯ | ◯ |
| P.B-R | ◯ | ◯ | ◯ | ◯ | ◯ | ◯ | ◯ | ◯ | ◯ | ◯ | ◯ |
| SiO2-ER | 4.03 | 1.59 | 10.50 | 6.50 | 4.81 | 4.20 | 4.08 | 3.42 | 3.08 | 2.52 | 1.70 |
| AL-ER | 18.70 | 6.80 | 16.00 | 12.50 | 9.2 | 5.70 | 5.00 | 5.90 | 3.80 | 3.80 | 5.20 |
| pH | 3.90 | 3.70 | 3.80 | 4.60 | 5.5 | 8.90 | 8.90 | 9.00 | 9.30 | 9.30 | 9.20 |

### Comparative Example

TABLE 8

| | Example | | | | | | | |
|---|---|---|---|---|---|---|---|---|
| | 1 | 2 | 3 | 4 | 5 | 6 | 7 | 8 |
| Composition | | | | | | | | |
| DMAC | 100.00 | | | | | | 80.00 | |
| NMP | | 100.00 | | | | | | 80.00 |
| γ-BL | | | 100.00 | | | | | |
| ACETONE | | | | 100.00 | | | | |
| HF | | | | | | 1.00 | 10.00 | 10.00 |
| DIW | | | | | | 99.00 | 10.00 | 10.00 |
| H3PO4 | | | | | | | | |
| H3PO3 | | | | | | | | |
| H3PO2 | | | | | | | | |
| MDEA | | | | | 100.00 | | | |
| TEA | | | | | | | | |
| Evaluation Results | | | | | | | | |
| P.P-R | X | X | X | X | X | ◯ | ◯ | ◯ |
| P.B-R | ◯ | ◯ | ◯ | ◯ | X | X | Δ | Δ |
| SiO2-ER | 0.00 | 0.00 | 0.01 | 0.00 | 0.00 | 2.50 | 2.67 | 2.09 |
| AL-ER | 0.00 | 0.00 | 0.00 | 0.00 | 0.00 | 300.00 | 126.10 | 244.00 |
| pH | 7.20 | 7.20 | 4.30 | 6.10 | 9.90 | 2.90 | 3.10 | 3.00 |

TABLE 9

| | Example | | | | | | |
|---|---|---|---|---|---|---|---|
| | 9 | 10 | 11 | 12 | 13 | 14 | 15 |
| Composition | | | | | | | |
| DMAC | | 79.00 | | | 77.00 | | |
| NMP | | | 79.00 | | | 77.00 | |
| γ-BL | 80.00 | | | 79.00 | | | 77.00 |
| ACETONE | | | | | | | |
| HF | 10.00 | 1.00 | 1.00 | 1.00 | 1.00 | 1.00 | 1.00 |
| DIW | 10.00 | 20.00 | 20.00 | 20.00 | 15.00 | 15.00 | 15.00 |
| H3PO4 | | | | | | | |
| H3PO3 | | | | | | | |
| H3PO2 | | | | | 7.00 | 7.00 | 7.00 |
| MDEA | | | | | | | |
| TEA | | | | | | | |
| Evaluation Results | | | | | | | |
| P.P-R | ◯ | ◯ | ◯ | ◯ | ◯ | ◯ | ◯ |
| P.B-R | Δ | X | X | X | X | X | X |
| SiO2-ER | 17.30 | 0.23 | 0.11 | 3.48 | 0.10 | 0.08 | 2.79 |
| AL-ER | 7.30 | 62.70 | 49.20 | 10.40 | 8.20 | 3.20 | 0.90 |
| pH | 3.10 | 3.40 | 2.60 | 3.30 | 1.70 | 1.70 | 2.00 |

What is claimed is:

1. A method for removing a protective layer composed of a protective coating and a primer coating for wet-etching process for use in the fabrication process of micro-electro-mechanical systems, by using a composition for removing the protective layer containing
(A) at least one organic solvent selected from the group consisting of amides, lactones, pyrrolidones and ketones,
(B) water, and
(C) a fluoride,
wherein the composition contains the component (A) in an amount of 80.00 to 99.90 mass %, the component (B) in an amount of 0.05 to 12.00 mass %, and the component (C) in an amount of 0.05 to 8.00 mass %.

2. The method for removing a protective layer according to claim 1, by using a composition for removing the protective layer further containing as component (D) at least one selected from the group consisting of phosphoric acid, phosphonic acid and phosphinic acid in an amount over 0 mass part to 5.5 mass parts based on 100 mass parts of the composition containing the component (A) in an amount of 80.00 to 99.90 mass %, the component (B) in an amount of 0.05 to 12.00 mass %, and the component (C) in an amount of 0.05 to 8.00 mass %.

3. The method for removing a protective layer according to claim 1, by using a composition for removing the protective layer further containing as component (E) an organic amine in an amount over 0 mass part to 45 mass parts based on 100 mass parts of the composition containing the component (A) in an amount of 80.00 to 99.90 mass %, the component (B) in an amount of 0.05 to 12.00 mass %, and the component (C) in an amount of 0.05 to 8.00 mass %.

4. The method for removing a protective layer according to claim 1, by using a composition for removing the protective layer further containing as component (D) at least one selected from the group consisting of phosphoric acid, phosphonic acid and phosphinic acid in an amount over 0 mass part to 5.5 mass parts and as component (E) an organic amine in an amount over 0 mass part to 45 mass parts, based on 100 mass parts of the composition containing the component (A) in an amount of 80.00 to 99.90 mass %, the component (B) in an amount of 0.05 to 12.00 mass %, and the component (C) in an amount of 0.05 to 8.00 mass %.

5. The method for removing a protective layer as set forth in claim 1, wherein the protective layer comprises a protective coating and a primer coating for wet-etching process for use in the fabrication process of micro-electro-mechanical systems, wherein the primer coating is a coating prepared from an organosilane and/or an aromatic silane dissolved in an organic solvent, and the protective coating is a coating made of a thermoplastic copolymer prepared from (a) styrene, (b) acrylonitrile, and (c) optionally at least one monomer selected from the group consisting of methacrylate, acrylate, vinyl benzyl chloride, and diester of maleic acid or fumaric acid.

6. The method for removing a protective layer as set forth in claim 1, wherein the protective layer comprises a protective coating and a primer coating for wet-etching process for use in the fabrication process of micro-electro-mechanical systems, wherein the primer coating is a coating prepared from an organosilane and/or an aromatic silane dissolved in an organic solvent, and the protective coating is a coating made of a thermoplastic copolymer prepared from (a) styrene, (b) acrylonitrile, and (c) optionally at least one monomer selected from the group consisting of methacrylate, acrylate, vinyl benzyl chloride, and diester of maleic acid or fumaric acid.

7. The method for removing a protective layer as set forth in claim 1, wherein the protective layer comprises a protective coating and a primer coating for wet-etching process for use in the fabrication process of micro-electro-mechanical systems, wherein the primer coating is a coating prepared from an organosilane and/or an aromatic silane dissolved in an organic solvent, and the protective coating is a coating made of a thermoplastic copolymer prepared from (a) styrene and (b) acrylonitrile.

8. The method for removing a protective layer as set forth in claim 1, wherein the protective layer comprises a protective coating and a primer coating for wet-etching process for use in the fabrication process of micro-electro-mechanical systems, wherein the primer coating is a coating prepared from a solution obtained by dissolving 3-[N-phenylamino]propyltrimethoxysilane in an organic solvent, and the protective coating is a coating made of a thermoplastic copolymer prepared from (a) styrene and (b) acrylonitrile.
